(19) United States
(12) Patent Application Publication
(10) Pub. No.: US 2008/0288421 A1
(43) Pub. Date: Nov. 20, 2008

(54) Method and Device Arrangement for Digitally Franking Postal Articles

(75) Inventors: Ingo Schubert, Darmstadt (DE); Guido Kienast, Radevormwald (DE); Carsten Vullriede, Hodenhagen (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: DEUTSCHE POST AG, Bonn (DE)

(21) Appl. No.: 11/659,395

(22) PCT Filed: Jul. 6, 2005
(86) PCT No.: PCT/EP05/07296

§ 371 Date: Mar. 3, 2008

(30) Foreign Application Priority Data
Aug. 2, 2004 (DE) 10 2004 037 695.6

(51) Int. Cl. G07B 17/02

(52) U.S. Cl. 705/402; 705/406

(57) ABSTRACT

Method for digitally franking postal articles during which a digital postage paid impression is generated by a computer and applied to a postal article. Postal article-specific data for one or more postal articles to be created are generated in a first computer at a customer, and the access to a remote second computer at a service provider is granted. Postal article-specific data for one or more postal articles are transmitted to the second computer. The postal article-specific data are processed in the second computer, and data for a digital postage paid impression are generated for each postal article. Afterwards, processing data are transmitted to accounting component, and a deduction of the franking is carried out at the customer. The postal-article specific data are transmitted with a digital postage paid impression for each postal article to be created to the first computer, and the data are recorded in the first computer. The postal article-specific data are then sent to a processor, and the data are printed for each respective postal article, whereupon the printed postal articles are placed in envelopes in the processor.

The invention relates to a method for digitally franking mailpieces, in which a digital postage indicium is generated by a computer means and applied onto a mailpiece.

The invention also relates to a device arrangement for digitally franking mailpieces, comprising a computer means in which a digital postage indicium can be generated and which has a processing means that is configured in such a way that it applies a digital postage indicium onto a mailpiece.

In the realm of the franking of mailpieces, various methods and devices are known that especially streamline the shipment of large volumes of mailpieces. Here, the conventional type of franking involving stamps is augmented by franking using franking machines that can be purchased by a customer in order to print postage indicia directly onto mailpieces in large quantities. Such devices normally call for loading postage amounts onto a machine. The postage indicia typically contain encrypted information that render the postage indicium as individualized as possible for purposes of payment assurance. The encrypted information can be applied, for example, in the form of a barcode or a matrix code.

Another area of IT franking consists of application programs that are installed on the computer of a customer. The customer can read in mailpiece-specific data from various sources into the application program and generate digital postage indicia that are printed directly onto a mailpiece. In this context, the franking can be printed, for example, onto an address label or directly into the address field of a letter. Application programs used for this type of IT franking typically have several additional functions such as postage optimization, the generation and evaluation of mailpiece lists and/or the administration of address lists. The printed postage indicia can be invoiced at a delivery service such as a postal service provider ahead of time or else after the franked mailpieces have been posted at the delivery service.

The objective of the invention is to provide a method and a device arrangement for digitally franking mailpieces that give the customer greater handling flexibility in comparison to the known version of franking using an installed application program at the premises of a customer. Moreover, the method and the device should provide a delivery service with the possibility of offering various additional services.

According to the invention, this objective is achieved by a method having the features of the independent Claim 1 and by a device having the features of the independent Claim 9. Additional advantageous embodiments of the method and of the device ensue from the subordinate Claims 2 to 8 and 10 to 11.

The method according to the invention for digitally franking mailpieces in which a digital postage indicium is generated by a computer means and applied onto a mailpiece comprises the following features:

generation of mailpiece-specific data for one or more mailpieces to be generated in a first computer means at the premises of a customer;

granting access to a remote second computer means at a service provider;

transmission of the mailpiece-specific data for one or more mailpieces to the second computer means;

processing the mailpiece-specific data in the second computer means, whereby data for a digital postage indicium is generated for each mailpiece;

transmission of processing data to an invoicing component and invoicing the customer for the franking service;

transmission to the first computer means of the mailpiece-specific data with a digital postage indicium for each mailpiece to be generated, and acquisition of the data in the first computer means;

transmission of the mailpiece-specific data to a processing means in conjunction with the first computer means; and

printout of the mailpiece-specific data for each mailpiece and enveloping the printed mailpieces in the processing means.

In an especially preferred embodiment of the invention, processing data generated in the second computer means during the processing is transmitted to an acceptance office for mailpieces and, when mailpieces are posted at an acceptance office for mailpieces, the mailpiece-specific data is acquired and the acquired data is compared to the processing data stored in the acceptance office. Advantageously, a payment assurance procedure can be carried out by means of this comparison.

In an especially preferred embodiment of the invention, the first computer means is connected to the second computer means via the Internet. During the processing of the mailpiece-specific data in the second computer means,. postage optimization is preferably carried out in addition to the generation of digital postage indicia. Moreover, during the processing of the mailpiece-specific data in the second computer means, the data can be sorted according to definable sorting criteria. The sorting can be carried out on the basis of postal codes or on the basis of routing regions or routing zones.

The invention also comprises a device arrangement for digitally franking mailpieces, comprising a computer means in which a digital postage indicium can be generated and which has a processing means that is configured in such a way that it applies a digital postage indicium onto a mailpiece. The device arrangement comprises a first computer means at the premises of a customer for generating mailpiece-specific data for one or more mailpieces that are to be generated and means for transmitting the data from the first computer means to a remote second computer means at a service provider.

The arrangement also comprises means for access control by the first computer means to the second computer means, whereby the second computer means is configured to process mailpiece-specific data, and here, data for a digital postage indicium is generated for each mailpiece. By means of an invoicing component, the customer is invoiced for the services that were provided in the area of digital franking and various additional functions.

Within the arrangement, means are also provided with which processed data containing information for a digital postage indicium for each mailpiece is transmitted from the second computer means to the first computer means and likewise provided are processing means, in conjunction with the first computer means, for printing out and enveloping the printed-out mailpieces.

In an especially preferred embodiment of the invention, the means for transmitting mailpiece-specific data between the computer means is the Internet. The second computer means preferably encompasses an Internet application.

The method according to the invention and the appertaining device arrangement entail a number of advantages for the digital franking of mailpieces. First of all, it is no longer necessary for customers to install an application program on their computer systems; instead, the required functions are available to them without any special adaptation of their systems. This mean especially that the maintenance effort on the part of customers is very low and, for example, they do not need any updates.

Moreover, the system has the advantage that it gives the customer a high degree of flexibility when it comes to the selection of a site for generating and processing mailing data. Thus, customers do not have to install and maintain an application program at all of their locations but rather, with the arrangement according to the invention, they can access the Internet application of the new IT franking from any desired location.

Secondly, a delivery service such as a postal service provider can use the execution of IT franking according to the invention to offer a service in conjunction with several other additional functions. This also means a shifting of the IT franking into the area of a delivery service, which can lead to a simplification of the invoicing and payment assurance procedures.

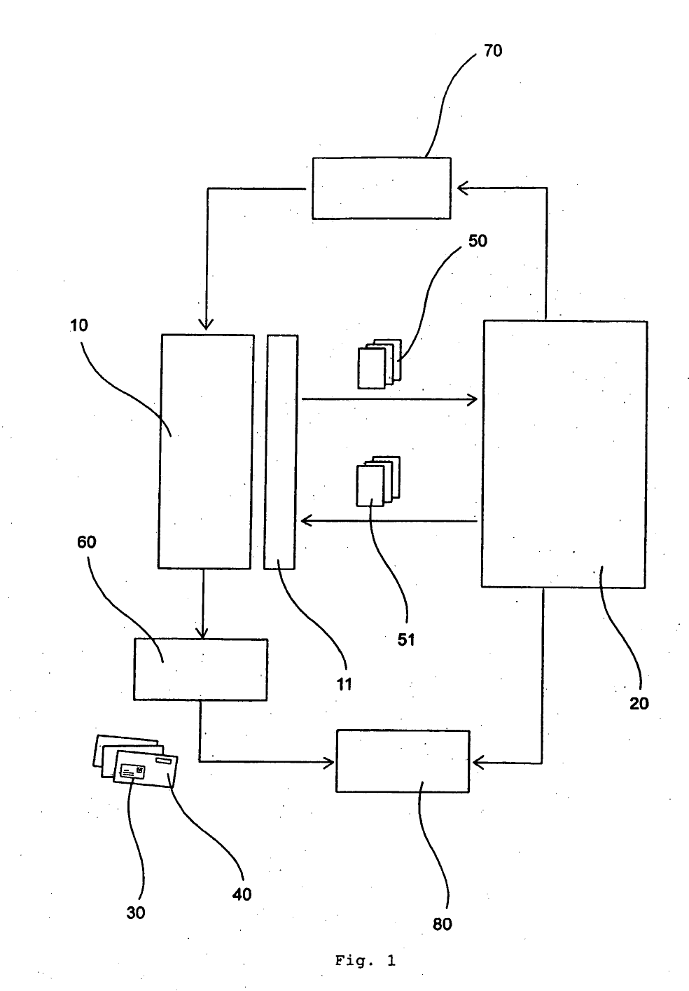

Additional advantages, special features and practical refinements of the invention can be gleaned from the subordinate claims and from the depiction below of preferred embodiments making reference to FIG. 1. FIG. 1 shows an especially preferred embodiment of the device arrangement according to the invention, with a schematic depiction of the data streams.

FIG. 1 schematically shows the process sequences according to the invention within an arrangement for digital franking. The appertaining system comprises first computer means 10 located in the area of a customer system in which contents for mailpieces 30 are generated and sent. The customers are preferably users who regularly generate a large number of mailpieces. This is the case, for example, for companies that regularly send out invoices, information mailings or advertising material. Within the customer system 10, mailpiece-specific data 50 is generated for one or more mailpieces. The mailpieces are generated with information from various sources such as databases for addresses, text documents and financial data.

A processing means 60 for printing out data and for inserting printed-out documents into envelopes is connected to the first computer means 10. The data can be printed out on conventional printer systems that are preferably adapted to handle a large printing volume. Known enveloping systems fold the documents and insert them into envelopes.

Normally, the first computer means 10 comprises means for the digital franking of mailpieces and for the immediate printing out in a processing means 60. An essential feature of the method according to the invention for digitally franking mailpieces lies in the fact that the process of generating digital postage indicia is carried out in conjunction with additional functions in a second computer means 20 that is located remotely from the first computer means. Unprocessed mailpiece-specific data 50 is thus transmitted to the second computer means and processed there. The second computer means is located in the area of a service provider that offers the digital franking with several additional functions.

The second computer means 20 is preferably connected to the first computer means 10 via the Internet and the data is provided in the XML format to the second computer means from the various customer systems. Various methods can be used to sort the data from the customer systems. For example, the, data can be integrated via a method encapsulation and directly further processed. For instance, this manner, the business logic of the customer system can be utilized. In another embodiment, the integration is carried out via a shared database. However, this modality has specific drawbacks since the business logic of the customer has to be developed anew.

In a preferred embodiment of the invention, which is shown in FIG. 1, the customer data is integrated into the second computer means 20 via an adapter 11 that can also be referred to as a wrapper. Thus, a customer's existing business logic can be integrated using the adapter, which is capable of adapting a technically non-conforming interface to the new requirements of the second computer means 20.

In an especially preferred embodiment of the invention, the access by the first computer means to the functions of the second computer means is carried out via an Internet application that the customer can call. The customer is preferably registered in the system of the second computer means and stored together with specific data. The registration comprises the issuing of an authorization means, whereby this is advantageously a password. At the time of the registration of a customer with a service provider, at least one contract is drawn up. A contract is an agreement between the service provider for the digital franking (IT franking) and a customer. According to the contract, the customer is invoiced for the IT franking provided. A contract preferably contains a contract number and a participation number of a posting center for the mailpieces under this contract. The posting center can be defined, for example, by a postal code or by specifying a routing region. For example, a 2-digit number can define a specific posting center for the specification of a routing region. In addition to specifying a posting center, a contract can also be augmented by additional information such as a defined pick-up run at the premises of a customer or at a depot.

It has proven to be advantageous for a customer to be able to enter into several contracts with a service provider, said contracts relating especially to different posting centers or different mail categories. For example, it is advantageous to draw up different contracts for mailpieces such as Infopost and normal letter mailings since these mail categories are invoiced differently.

When the home page of the Internet application is accessed, the user is presented, for example, with a login mask of the application. The user can enter his user name and password. Moreover, a multi-digit customer ID can be entered. On the basis of this login information, an authentication is carried out via a login medium (as a rule, a database). Once the authentication has been successful, in an especially preferred embodiment of the invention, the user accesses a personal home page of the application with a personalized menu compiled in accordance with the user rights of the customer.

In an especially preferred embodiment of the invention, the customer can call various profiles under which he would like to act in the application. The profiles, called “clients” in this description, can be created, changed and selected by the customer. The use of different client profiles has the advantage, among other things, that a company can create different profiles for different locations or corporate divisions. Therefore, the second computer means of a service provider can be accessed from various locations, whereby each location can arrange to have different mailpieces generated and processed, for example, each with their own sender address. Moreover, it is possible to call different profiles from a central location and, at this location, to generate mailpieces that are appropriately personalized for several locations.

In order to act in the Internet application, the customer preferably also enters the contract according to which supplied data is to be processed. In this manner, the processed data is associated with at least one participation number of a posting center 80 where mailpieces are accepted under this contract. Processing data generated during the processing can be transmitted to the appropriate posting center for purposes of comparing the data.

A class is used in order to access the data maintenance of the customer. This interpreter uses an XML description to control the database functions that are to be called and assumes the management of the database connection. The architecture of the Internet application can be achieved in different ways. For example, a 2-tier architecture with a Tomcat web and application server is a possibility. Moreover, a 3-tier architecture with an Enterprise web and application server such as Bea Weblogic can be used.

The 2-tier variant can combine front-end, business logic and data access modules of the application on one machine. The data maintenance is preferably implemented with proprietary JDBC accesses to an Oracle database or can be individually encapsulated in stored procedures. The application can be clustered using a hardware load balancer and an upstream Apache web server.

In the case of the 3-tier architecture, front-end and business components can be installed on two separate machines. The access to the databases and to the transaction management are handled by the application server and are preferably carried out using Enterprise JavaBeans (EJBs). The web components as well as the application components can be clustered, thus allowing a higher overall performance in comparison to the 2-tier variant. The 2-tier variant can be combined with the IT franking back-end in which all of the mailpiece files are processed. In the 3-tier architecture, an IT franking back-end is present on each application server so that mailpiece files can be processed by different computers with an eye towards a distribution of the load. Both variants are advantageously safeguarded vis-a-vis the WorldWideWeb with a firewall. In the 3-tier variant, if necessary, the application layer could also be safeguarded with a firewall.

In an especially preferred embodiment of the invention, the structure of the second computer means 20 can be divided into three different horizontal layers. These arise primarily from their different tasks or responsibilities and are preferably only secondarily determined by differentiated physical components.

The first layer, which will be referred to below as the Presentation Layer (Web Layer), contains all of the components needed for the display and interaction control of the application. First and foremost, this is a Controller Servlet that initiates a business process. This business process can extend over several technically related individual actions which, in turn, are displayed in JSP pages. In order for the business subject (e.g. transaction semantics, the sequence of the individual actions, etc.) to remain consistent at every point in time, the individual business steps are combined by means of the controller servlet.

Session tracking is employed in order to control the business processes with an eye towards the unambiguous identification of the user. This session tracking is part of the Session-Management that uses cookies or, as an alternative (for example, if the user does not accept any cookies and has deactivated them on the client or web browser), uses URL rewriting as a mechanism for recognition. In order to ensure the consistency of the form data and form processing, validation and plausibility controls are integrated into the web layer and these are based on the form framework JForm. Every action initiated by the user pertaining to the business logic is imaged using event components that, at the same time, constitute the interface to the business logic layer.

A second layer, Business Logic Layer, connects all of the application components that carry out business processes directly or that work with business objects. They are preferably augmented or controlled by another component that deals with the functionality of the authorization and authentication of users and application areas.

In a preferred embodiment, the application components implement the following functionalities:

an Admin Interface comprises the administration of users, roles and access rights of the system. Moreover, clients can be set up and their customer master data can be maintained here.

a Management Module allows the maintenance of contracts, products/prices and Infopost production samples.

In a Statistics Module, the application logic for generating and providing statistics such as monthly and daily evaluations is implemented.

A Report component ensures access to the reports generated by an IT franking server, processes them for display or, if applicable generates additionally needed meta information.

An Auditing Module comprises the functionality for examining invoices, that is to say, for comparing, displaying and canceling invoices.

An Upload/Download interface allows a client to upload his mailing data (XML files) that have been exported out of the ERP system for purposes of processing it in the IT franking back-end. The optimized mailpiece files generated by the IT franking back-end is subsequently made available for downloading.

A Back-end Connector represents the interface to the IT franking back-end. It allows access to back-end functionalities that might be necessary such as, for example, the transmission of processing statuses relating to posted mailpiece files. Another possibility is the status control of the IT franking server as another back-end function.

All of the necessary business process data is stored in a third layer, Persistence Layer. In an especially preferred embodiment of the invention, a constituent of this layer is at least one Oracle database. All of the business objects present in the Business Logic Layer can persistently image their status and data records by means of defined functions. These include especially:

information about users, roles and rights,

customer master data,

address data,

data on production samples,

contract data

price and product data

payment invoicing data (cost centers, product sums, discounts)

monitoring data of processing procedures.

The focal point of the processing of the mailpiece-specific data in the second computer means 20 lies in the generation of a digital postage indicium for several mailpieces of a customer. This is preferably encrypted information that can be displayed graphically. For example, barcodes or matrix codes can be used as the display. The content of the encrypted information can comprise various levels as is known for the conventional encryption methods in digital franking. For example, the encryption can process random numbers, fixed or variable keys, date information and/or sender data or recipient data.

The information generated by the encryption for a postage indicium is associated with a mailpiece and transmitted to the first computer means. The information for postage indicia can be augmented by additional information such as customer-specific advertising imprints or data about the service provider. The first computer means 10 can store the processed data after receipt and, if applicable, can further process it or transfer it directly to a processing means 60 that prints out the mailpieces together with the digital postage indicia. This can be done in a generally known manner in that a digital postage indicium is printed into the address field of a mailpiece. If the mailpiece is inserted into an envelope, then the postage indicium is visible and legible through the transparent window of the address field. In another embodiment of the invention, the postage indicium is printed onto a label that can be applied onto a mailpiece.

The franked mailpieces 30 are transported to a posting center 80 defined by the appropriate contract, and this is where they are handed over to a delivery service. It has proven to be advantageous for the operator of the delivery service to be connected to the service provider of the digital franking for purposes of exchanging information. In particular, processing data is transmitted from the second computer means 20 to a posting center 80 so that a comparison between acquired and stored data can be carried out. In this manner, various stages of a payment assurance procedure can be carried out. For example, a random comparison of posted mailpieces with mailpiece information such as lists can be made. At a higher security level of the payment assurance, the postage indicium of each posted mailpiece can be acquired and its validity can be checked on the basis of the encrypted information.

The processing of mailpiece-specific data in the second computer means 20 can comprise further additional functions, along with the generation of digital postage indicia 40 for each mailpiece. For example, the supplied data can be sorted according to predefinable criteria. It has proven to be especially advantageous to sort the data on the basis of an applicable postal code. With this sorting, the customer has the possibility to print out and to envelope in sorted form the data processed by the service provider. This produces bundles of franked and already sorted mailpieces that can be posted, for example, in containers, at a posting center.

Here, the possibility exists that a customer will receive a discount on the mailing costs, thanks to the sorting. In another embodiment of the invention, a discount is only granted for preliminary performances if the mailpieces are sorted according to additional criteria such as a routing region or a routing zone. Preferably, the customer can choose which degree of sorting he would select for execution during the sorting procedure.

The invoicing of the services of the second computer means is carried out via an invoicing component in conjunction with the computer means. The Internet application of the second computer means can also allow common additional. functions such as the storage of payment invoices or mailpiece lists.

### LIST OF REFERENCE NUMERALS

10 first computer means; user

20 second computer means; service provider

30 mailpiece

40 postage indicium

50 mailpiece-specific data; unprocessed

51 mailpiece-specific data; processed

60 processing means

70 invoicing component

80 postal service provider

1. A method for digitally franking mailpieces, in which a digital postage indicium is generated by a computer and applied onto a mailpiece, comprising the following steps:
registering a customer, comprising drawing up at least one agreement that contains an unambiguous contract number and a participation number of a posting center;
generating mailpiece-specific data for one or more mailpieces to be generated in a first computer at the premises of the customer;
granting access to a remote second computer at a service provider;
authorizing the customer and selecting an agreement of a customer;
transmitting the mailpiece-specific data for one or more mailpieces to the second computer;
processing the mailpiece-specific data in the second computer, whereby data for a digital postage indicium is generated for each mailpiece;
transmitting processing data to an invoicing component and invoicing the customer for the franking service;
transmitting the first computer the mailpiece-specific data with a digital postage indicium for each mailpiece to be generated, and acquiring the data in the first computer;
transmitting the mailpiece-specific data to a processor in conjunction with the first computer;
printing out the mailpiece-specific data for each mailpiece and enveloping the printed mailpieces in the processor;
associating the processed mailpiece-specific data with the participation number of the posting center of the selected agreement of the customer and determining the posting center, whereby the processing data generated in the second computer during the processing are transmitted to the determined posting center for mailpieces and, when mailpieces are posted at the posting center for mailpieces, acquiring the mailpiece-specific data and comparing the acquired data to the processing data stored in the posting center.

2. The method according to claim 1, comprising carrying out a payment assurance procedure by means of a comparison in the posting center.

3. The method according to claim 1, wherein the first computer is connected to the second computer via the Internet.

4. The method according to claim 1, comprising during the processing of the mailpiece-specific data in the second computer, postage optimization.

5. The method according to claim 1, comprising during the processing of the mailpiece-specific data in the second computer, sorting the data according to sorting criteria that can be selected by the customer.

6. The method according to claim 5, comprising carrying out the sorting on the basis of postal codes.

7. The method according to claim 5, comprises carrying out the sorting on the basis of routing regions or routing zones.
